(19) United States
(12) Patent Application Publication
(10) Pub. No.: US 2010/0062620 A1
(43) Pub. Date: Mar. 11, 2010

(54) SIM CARD CONNECTOR HAVING DUAL-SET FOOTPRINT ARRANGEMENTS

(75) Inventors: GAO-BING LEI, ShenZhen (CN); NAN HU, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Taipei Hsien (TW)

(21) Appl. No.: 12/554,196

(22) Filed: Sep. 4, 2009

(30) Foreign Application Priority Data
Sep. 9, 2008 (CN) 200820185541.6

(51) Int. Cl. H01R 12/00

(52) U.S. Cl. 439/66

(57) ABSTRACT

Provided is an electrical connector comprises an insulative housing defining a mounting surface and a mating surface in a parallel relationship and surrounded by a pair of end portions and side edges. A plurality of contacts are arranged into two distinct rows, and each contact comprises a first solder tail and a second solder tail respectively extending outward from the end portion and the side edge of the insulative housing.

### BACKGROUND OF THE INVENTION

1. Field of the Invention

The present invention relates to a Subscriber Identity Module (SIM) card connector, and more particularly to a SIM card connector having a plurality of contacts with dual-set solder tails so as to suit for different layout of a printed circuit board (PCB).

2. Description of the Related Art

SIM cards are increasingly used in mobile telephones. The SIM card comprises an electronic chip that supplies the telephone with information identifying the user, whereby without the SIM card the telephone is inoperational. The SIM card may be removed and replaced with another SIM card for example when different users have access to the same telephone.

A conventional SIM card connector for connecting the SIM card with the printed circuit board comprises a housing bounded by a rectangular periphery comprising opposed sides extending between opposed ends, and a plurality of terminals, each comprising a longitudinal spring beam section and a contact protrusion, the contact protrusions being arranged in two rows along both ends, and the spring beam sections extending therefrom at an angle less than 90 degrees with respect to the row, such that the contact protrusions make contact with two parallel rows of aligned SIM card circuit pads. Each contact comprises a solder tail projecting out of the housing for soldering onto the printed circuit board.

In order to meet the new layout on the PCB, a new card connector has to be introduced so as to meet the requirement.

### SUMMARY OF THE INVENTION

Accordingly, an object of the present invention is to provide a SIM card connector suit for different layout of a printed circuit board.

In order to achieve the object set forth, an electrical connector comprises an insulative housing defining a mounting surface and a mating surface in a parallel relationship and surrounded by a pair of end portions and side edges. A plurality of contacts are arranged into two distinct rows, and each contact comprises a first solder tail and a second solder tail respectively extending outward from the end portion and the side edge of the insulative housing, respectively.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a SIM card connector in accordance with the present invention;

FIG. 2 is an exploded perspective view of the SIM card connector shown in FIG. 1;

FIG. 3 is a side view of the SIM card connector shown in FIG. 1;

FIG. 4 is a top view of the SIM card connector shown in FIG. 1;

FIG. 5 is a top view of the SIM card connector mounting onto a first layout of a printed circuit board; and

FIG. 6 is a top view of the SIM card connector mounting onto a second layout of the printed circuit board.

### DETAILED DESCRIPTION OF THE INVENTION

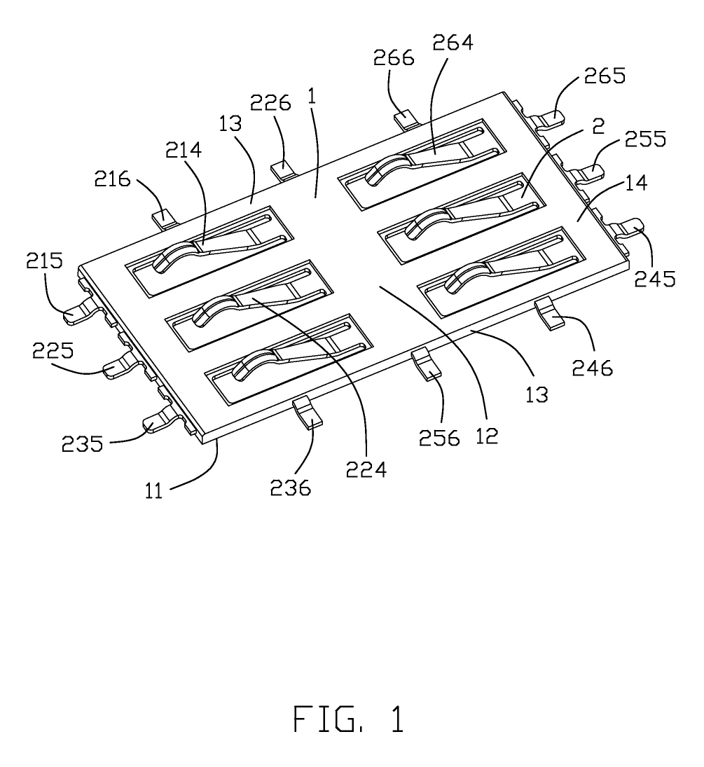

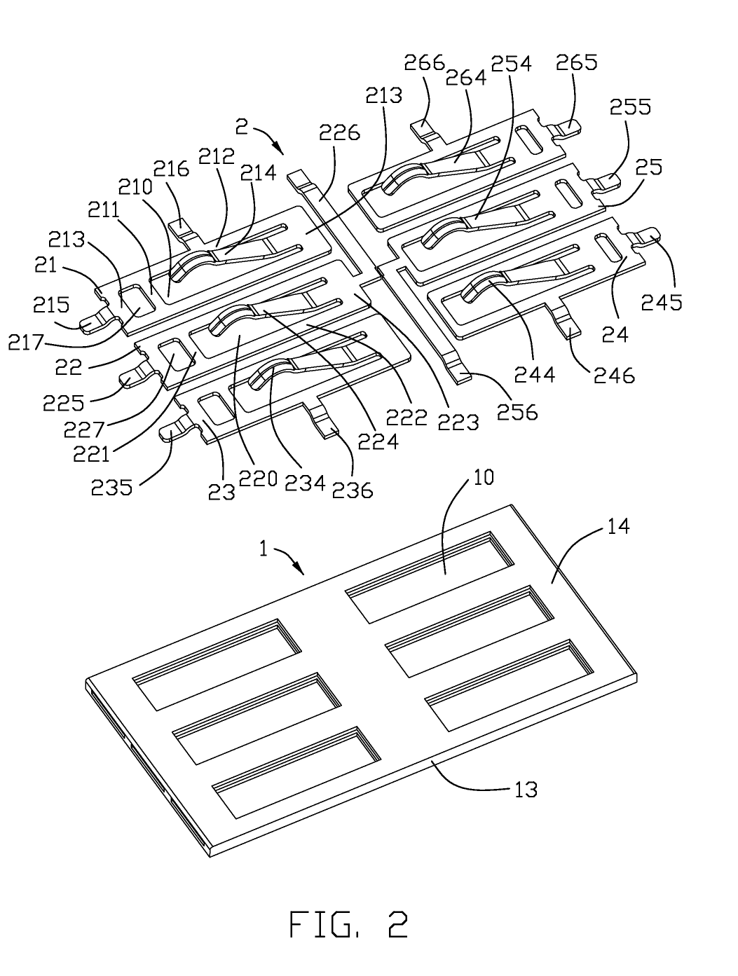

Reference will now be made to the drawing figures to describe a preferred embodiment of the present invention in detail. Referring to FIGS. 1-2, a SIM card connector according to the preferred embodiment of the present invention is provided and comprises an insulative housing 1 and a plurality of contacts 2 mounted therein.

The rectangular insulative housing 1 has a frame configuration and defines a mating surface 12 for mating with a SIM card and a mounting surface 11 for mounting onto a printed circuit board (PCB). The insulative housing 1 further defines a pair of longitudinal side edges 13 and a pair of end portions 14 connecting the side edges. A plurality of receiving recesses 10 are defined on the insulating housing 1 and arranged into two rows for receiving said contacts 2 therein.

The contacts 2 comprises six similarly configured contacts which are respectively numerated as 21, 22, 23, 24, 25, 26 and divided into two groups. The first group of contacts comprises a pair of first contacts 21, 23 and a second contact 22 sandwiched between said first contacts 21, 23. The first contact 21 has a rectangular plate like base portion 211 defining a pair of longitudinal side edges 212 and a pair of end portions 213 connecting said side edges 212. A first resilient arm 214 extends upwardly from one end portion 213 thereby leaving an elongated opening 210 in the base portion 211. A first solder tail 215 extends along a same direction (i.e. a first direction) as the resilient arm 214 from the other end portion 213. An aperture 217 is defined within the base portion 211 adjacent to the first solder tail 215. A second solder tail 216 extends outwardly along a second direction from a middle portion of the side edge 212 and is in a perpendicular relationship with the first solder tail 215. The other first contact 23 also comprises a resilient arm 234, a first solder tail 235 and a second solder tail 236, while the second solder tails 236 extends reversely relative to the second solder tail 216.

The second contact 22 is nearly a same configuration as the first contact 21, and comprises a base portion 221, an opening 220, a pair of side edges 222, a pair of end portions 223, a resilient arm 224, a first tail 225, a second tail 226 and an aperture 227. Different from the first contact 21, the second tail 226 of the second contact 22 firstly extends along an opposite direction relative to the first tail 225 from the end portion 223 and then extends at an angle of 90 degrees with respect to the side edge 222.

The second group of contacts also comprises a pair of first contacts 24, 26 and a second contact 25 sandwiched therebetween. The basic configuration of the three contacts are same as that of the first group, the only difference is resilient arms 244, 254, 264 and first solder tails 245, 255, 265 respectively extend from a same end portion but along opposite directions. The second group of contacts also comprises second solder tails 256, 246, 266.

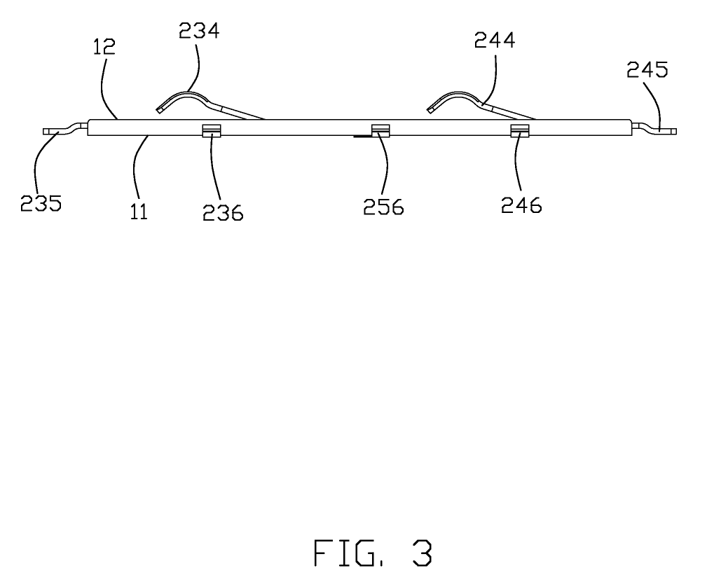

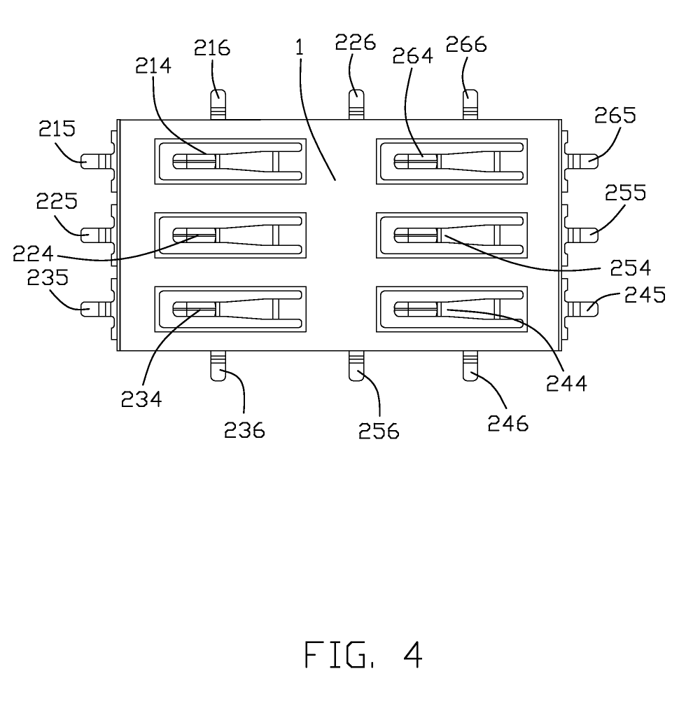

Referring to FIGS. 3-4, the contacts 2 are inserted mold into the insulative housing 1. The base portion 211 of each contact is securely retained in the insulative housing 1 and the resilient arm 214 projects beyond the mating surface 12 through the receiving recess 10. The aperture 217 is filled by the insulative housing during the molding process thereby increasing the retaining force between the contacts 2 and insulative housing 1.

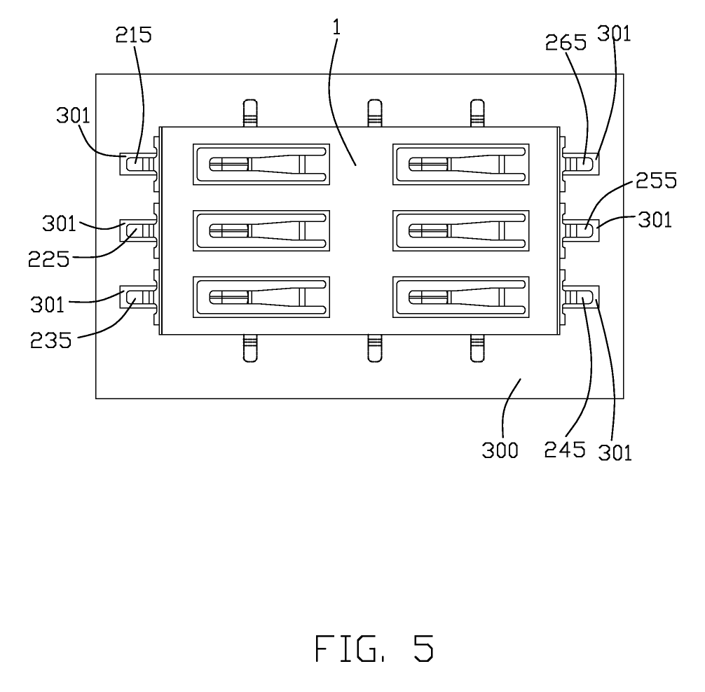

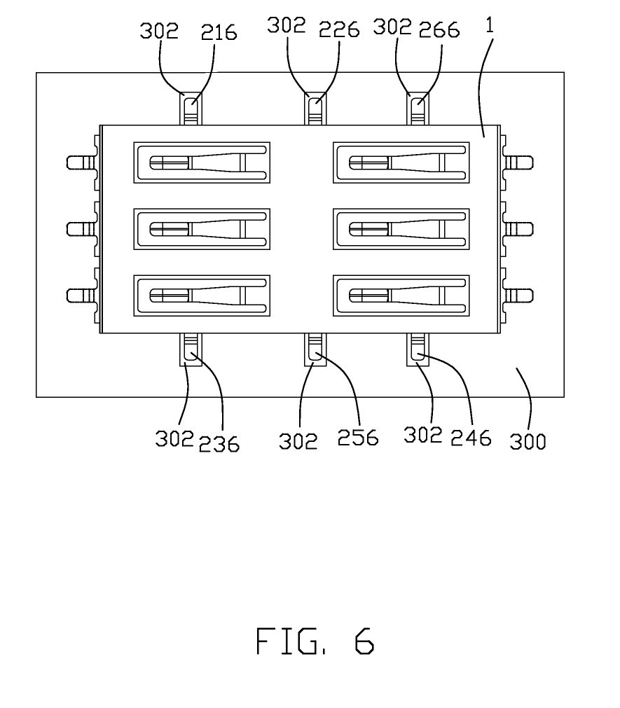

Referring to FIGS. 5-6, the first solder tails 215, 225, 235, 245, 255, 265 extend toward the mounting surface 11 through the end portions 14 and define a first mounting face suit for a first layout of a printed circuit board (PCB) 300. The PCB 300 defines a plurality of conductive pads 301 arranged into two transversal rows for respectively mounting the first solder tails thereon. Before soldering the first solder tails onto the conductive pads 301, the second solder tails can be removed by a special facility. The second solder tails 216, 226, 236, 246, 256, 266 extend toward the mounting surface 11 through the side edges 13 and define a second mounting face suit for a second layout of the PCB 300. The PCB 300 defines a plurality of conductive pads 302 arranged into two longitudinal rows for respectively mounting the second solder tails thereon. Before soldering the second solder tails onto the conductive pads 302, the first solder tails can also be removed by the special facility. The first and the second mounting faces can be arranged at different levels for suit to PCB in different thickness.

As the first solder tails and the second solder tails respectively extend from different sides of the insulative housing 1, therefore the electrical connector can be soldered onto at least two different layouts of the PCB. That is to say, if the original transversal arranged solder pad 302 on the PCB 300 is changed into a longitudinal arranged manner, the electrical connector can also be mounted onto the PCB 300 without changing any element.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing defining a mounting surface and a mating surface in a parallel relationship and surrounded by a pair of end portions and side edges;
a plurality of contacts arranged into two distinct groups, and each contact comprising a first solder tail and a second solder tail respectively extending outward from the end portion and the side edge of the insulative housing, respectively.

2. The electrical connector as described in claim 1, wherein the first solder tail and the second solder tail of each contact are in a perpendicular relationship.

3. The electrical connector as described in claim 2, wherein said contacts are inserted mold into the insulative housing, and said first solder tails and second solder tails respectively define a first mounting face and a second mounting face located at different levels.

4. The electrical connector as described in claim 2, wherein each contact has a resilient arm projecting beyond the mating surface, the resilient arm is substantially in line with the first solder tails while perpendicular to the second solder tails.

5. The electrical connector as described in claim 4, wherein each group of contacts comprises a second contact and a pair of first contacts, the second solder tail of the second contact is spaced to the second solder tails of the first contacts.

6. The electrical connector as described in claim 5, wherein the first solder tail and the second solder tail of the second contact extend from opposite sides of the second contact, while the first solder tails and the second solder tails of the first contacts extend from adjacent sides of each first contact.

7. An electrical connector comprising:
an insulative housing defining a pair of longitudinal side edges and a pair of transversal end portions connecting said longitudinal side edges, and a plurality of receiving recesses running along the longitudinal side edges; and a plurality of contacts retained in the corresponding receiving recesses;
wherein a plurality of first solder tails extend outwardly through the transversal end portions and a plurality of second solder tails extend outwardly through the longitudinal side edges thereby forming two different mounting regions.

8. The electrical connector as described in claim 7, wherein each contact comprises a resilient arm projecting beyond the insulative housing, and said resilient arms of the contacts are surrounded by the first and second solder tails.

9. The electrical connector as described in claim 7, wherein each of said contacts is unitarily formed with one of the first solder tails and one of the second solder tails.

10. The electrical connector as described in claim 7, wherein said contacts are arranged in two rows in a direction perpendicular to said longitudinal side edge, said a space defined between said two rows under condition that some of said second solder tails extend out of the longitudinal side edge from said space.

11. The electrical connector as described in claim 10, wherein an amount of said contacts are six with six said first solder tails and six said second solder tails among which three of said six first solder tails and the other three of said six first solder tails are respectively located on two opposite transverse end portions, while three of said six second solder tails and the other three of said six second solder tails are respectively located on the longitudinal side edges.

12. The electrical connector as described in claim 7, wherein said first solder tails and said second solder tails are respectively located at two different levels for mounting to different surfaces.

13. A SIM connector comprising:
a planar housing defining a mating interface and a mounting interface, at least a pair of passageways located horizontally across the mating interface;
first and second group of contacts each having a planar base portion disposed substantially within the passageway, respectively, each including a contact engaging portion extending beyond the mating interface; and
the contact terminals each including a first solder tail establishing a first set of footprint, and a second solder tail establishing a second set of footprint.

14. The SIM connector as described in claim 13, wherein the base portion includes an opening with contact engaging portion extending upward from an end of the opening.

15. The SIM connector as described in claim 13, wherein the first group of contacts includes first, second and third contacts arranged in side-by-side, and the second group of contacts includes fourth, fifth and sixth contact terminals arranged in side-by-side.

16. The SIM connector as described in claim 13, wherein one of the first and second solder tails are located at different sides of the base portion.

17. The SIM connector as described in claim 15, wherein the second and fourth contacts having their first and second solder tails located on opposite sides of the base portion.

18. The SIM connector as described in claim 13, wherein the first and second solder tails are located at different levels.

19. The SIM connector as described in claim 18, wherein the second solder tail is located between the mating interface and mounting interface.
